(19) United States
(12) Patent Application Publication
(10) Pub. No.: US 2002/0174578 A1
(43) Pub. Date: Nov. 28, 2002

(54) Themed decorative displays

(76) Inventor: Elizabeth Gail Ross, Oakland, CA (US)

Correspondence Address: MEDLEN & CARROLL, LLP, 101 HOWARD STREET, SUITE 350, SAN FRANCISCO, CA, 94105, US

(21) Appl. No.: 09/815,625

(22) Filed: Mar. 23, 2001

(51) Int. Cl. G09F 19/00

(52) U.S. Cl. 40/409

(57) ABSTRACT

A themed, decorative display is provided which includes a base; a transparent, liquid-filled container mounted on the base, a diorama mounted including fixed elements designed to convey a predetermined theme are provided inside the liquid-filled container, a plurality of movable elements inside the liquid-filled container shaped consistent with the theme for dispersing in the liquid for falling slowly through the liquid in response to the pull of gravity, and an electronic means preferably mounted in the base for automatically producing sounds consistent with said theme when a triggering event occurs.

### TECHNICAL FIELD OF THE INVENTION

This invention relates generally to novelty display devices, and more particularly to liquid filled crystal ball type devices which simulate snowfall.

### BACKGROUND OF THE INVENTION

Paperweights and other liquid filled novelty display devices having simulated snow flakes are well known in the art. For example, U.S. Pat. No. 2,361,424 to Snyder discloses a figure mounted within a transparent, liquid-filled container, and white particulate matter which can be dispersed in the liquid by shaking or inverting the container to simulate falling snow.

While such devices provide short-term entertainment, they typically are not particularly artistically or esthetically satisfying and, accordingly, provide no lasting interest to their owners. Accordingly, the need exists for display devices which provide more artistically creative and interesting effects which their owners will want to experience again and again.

### SUMMARY OF THE INVENTION

In one embodiment, the present invention provides a themed decorative display including a base, a transparent, liquid-filled container mounted on the base, a diorama mounted inside the liquid-filled container including fixed elements designed to convey a predetermined theme, a plurality of movable elements inside the liquid-filled container, the elements shaped consistently with the theme and of sufficient size and weight to be dispersed in the liquid when the liquid is moved or agitated and to fall slowly through the liquid in response to the pull of gravity, and an electronic means mounted in the base for automatically producing sounds consistent with the theme when a triggering event occurs.

In another embodiment, the present invention provides a themed decorative display including a base, a transparent, liquid-filled container mounted on the base, a diorama mounted inside the liquid-filled container including fixed elements designed to convey a predetermined theme, a plurality of movable elements inside the liquid-filled container, the elements shaped consistently with the theme and of sufficient size and weight to be dispersed in the liquid when the liquid is moved or agitated and to fall slowly through the liquid in response to the pull of gravity, and a sound chip mounted in the base for automatically producing sounds consistent with the theme when a triggering event occurs, the sound chip powered by an appropriate source of electricity, and the sound produced by the sound chip amplified so that it can be heard by a human. A timer can be interposed between the power source and the sound chip, or integrated onto the sound chip, for providing a preset period of time for replaying the sound stored in memory on the sound chip. A switch can be provided for initiating the timer and turning on the sound chip.

In yet another embodiment, the present invention includes a large themed decorative display which is too big to be easily inverted by a user, including a base, a transparent, liquid-filled container mounted on the base, a diorama mounted on a perforated diorama base mounted inside the liquid-filled container including fixed elements designed to convey a predetermined theme, a plurality of movable elements inside the liquid-filled container, the elements shaped consistently with the theme and of sufficient size and weight to be dispersed in the liquid when the liquid is moved or agitated and to fall slowly through the liquid in response to the pull of gravity, a magnetic stirring element positioned for rotation beneath said diorama base by a magnetic stirrer mounted in said base beneath said magnetic stirring element for continuously moving said liquid and said movable elements when the magnetic stirring element is rotated, and an electronic means mounted in the base for automatically producing sounds consistent with the theme when a triggering event occurs.

In yet another embodiment, the present invention includes a themed decorative display including a base, a transparent, liquid-filled container mounted on the base, a diorama mounted inside the liquid-filled container including fixed elements designed to convey a predetermined theme, a plurality of movable elements inside the liquid-filled container, the elements shaped consistently with the theme and of sufficient size and weight to be dispersed in the liquid when the liquid is moved or agitated and to fall slowly through the liquid in response to the pull of gravity, and an electronic means mounted in the base for automatically producing sounds consistent with the theme when a triggering event occurs, at least one of said fixed elements of the diorama incorporating an optical fiber or formed from a light transmitting material for transmitting light from a hidden location in the base to provide illumination for the theme, the optical fiber or element formed from light transmitting material being secured at one end to an inside surface of the container facing the base to receive light from a light source, such as an LED or small light bulb, mounted in the base adjacent an outside surface of the container.

Other and further objects, features, advantages and embodiments of the present invention will become apparent to one skilled in the art from reading the Detailed Description of the Invention together with the drawings.

### BRIEF DESCRIPTION OF THE DRAWINGS

FIG. 1 is a side view of a themed decorative display of the present invention;

FIG. 2 is a side view of a themed decorative display of the present invention.

FIG. 3 is a partially cut-away, side view of a themed decorative display of the present invention incorporating a lighted diorama element;

FIG. 4 is a side view of a themed decorative display of the present invention showing the base in broken line form and components mounted in said base.

### DETAILED DESCRIPTION OF THE INVENTION

A decorative display of the present invention is used for creating a three dimensional work of art which incorporates both visual and audible elements for communicating a predetermined theme.

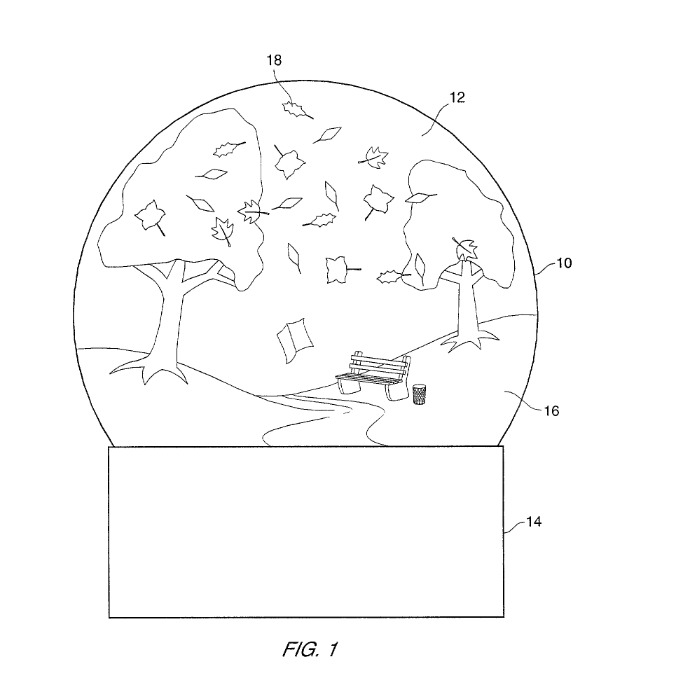

As shown in FIG. 1, a decorative display of the present invention includes a base 14 on which can be mounted a substantially transparent container 10 filled with a substantially transparent liquid 12. The external surface of base 14 can be used to display a title, quote, or inspirational passage, most preferably by debossing, carving, or sculpting. Base 14 is preferably hollow to provide an interior space, normally hidden from the view of the user, for mounting the sound, power and other components described in more detail below.

The preferred container 10 is a globe which is substantially spherical in shape, although other container shapes are also possible, and which is sealed to prevent the loss of liquid 12. Container 10 can be formed from almost any substantially transparent material of sufficient strength to support and contain the liquid 12 in either a normal or inverted position such as, for example, glass, plexiglass, or acrylic. Container 10 can be almost any size, from a small size which can be inverted to move or agitate the liquid 12, to a very large size which cannot be inverted and which is displayed on a stand or table top.

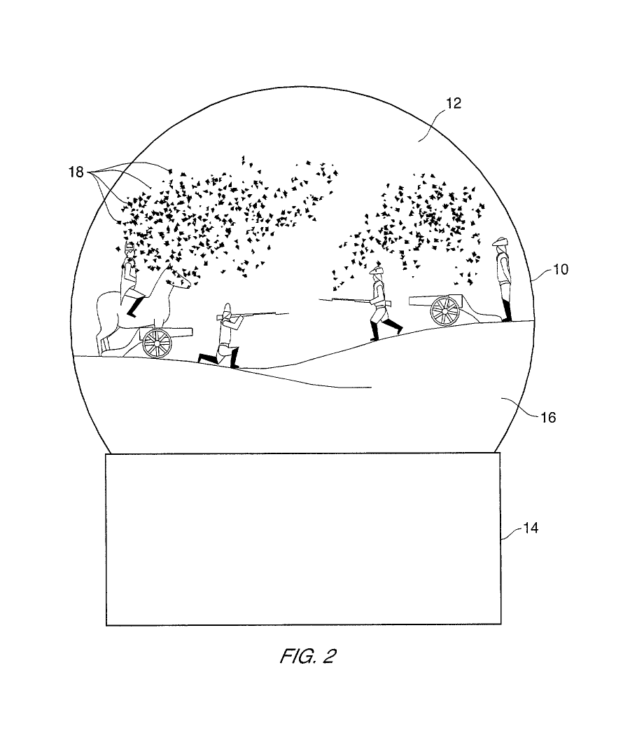

A diorama 16 having fixed elements is mounted inside container 10 according to a preselected theme. For example, the theme shown in FIG. 1 is “Autumn in Central Park,” and the fixed elements could include elements such as trees, a path through the trees, grass, a park bench, and trash container. Also present inside the container 10 are randomly moveable elements 18 which can be dispersed in the liquid 12 when the liquid is moved or agitated and which have a shape and/or color to coordinate with the theme. As shown in FIG. 1, the moveable elements 18 are shaped like leaves and can be colored autumnal browns, golds, and reds to coordinate with the theme. In addition, other moveable elements can be added to provide interest, such as, for example, a substantially to scale page from the New York Times. FIG. 2 shows an example of another kind of theme in which the diorama 16 contained inside the container 10 depicts, for example, a Napoleonic battle scene with soldiers engaged in combat in the center of the diorama, Wellington on the left hill, Napoleon on the right hill, and cannon or other elements. The randomly moveable elements 18 are comprised of fine black particles which swirl and eddy when the liquid 12 is moved to simulate battlefield smoke, revealing and enclosing the combattants in a random manner. As can be appreciated, a wide variety of diorama elements can be used to create a theme, such as, for example, a foot bridge, garden trellis, trees, shrubbery, fountain, koi pond, water lily or lotus, dandelions, bicycle leaning on a fence, man fishing by a stream, row boat, sailboat or kayak, garden statue, path through woods, train tracks through a field, see saw, swing, a boat dock and lake, magnolia tree with bench circling the tree, waterfall, japanese garden, cafe table and chairs, Buddha, stone path, heron in a stream, butterfly on a flowering branch, hummingbird, etc.

Moveable elements 18 are used to provide movement within the context of the theme, and can be cut, by laser or other conventional means, from thin metal foil, plastic film, or other materials which will not be deteriorated or substantially changed in shape or appearance by their exposure to the liquid 12 in the container. Moveable elements 18 can also be 3-D sculpted from materials having suitable density relative to liquid 12, such as plastic. Moveable elements 18 can be conventionally colored to coordinate with the preselected theme using, for example, paints, dyes, stains, and coatings. Moveable elements, in addition to those mentioned above for FIGS. 1 and 2, could include, for example, petals, butterflies, bees, dragonflies, birds, blossoms, rain (either small round droplets or silver shards), ash, dandelions, and the like. It is frequently preferable to use two or more different types of movable elements 18, i.e., elements which differ in size, shape, or color.

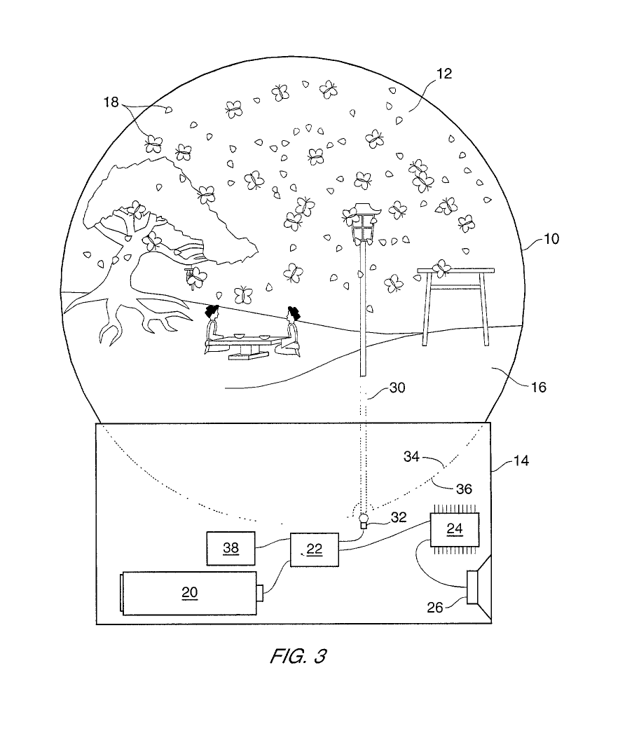

FIG. 3 shows, in the cutaway portion of the base, another aspect of a themed display of the present invention: a means for providing sound which is selected to coordinate with the selected theme. For example, a sound sequence used with the theme shown in FIG. 1 could be a sound from nature likely to be encountered in Central Park, such as the sound of a bird chirping or wind blowing through the trees, or the sound of leaves rustling. Or the sound could be music, such as a musical composition which evokes New York. Likewise, the sound used in conjunction with a theme such as is illustrated in FIG. 2 could be the sound of gun and cannon fire, the neighing of horses, galloping, clashing of swords and the like. Alternatively, the sound could be music evocative of the Napoleonic Wars, such as, for example, all or part of the 1812 Overture. The sound chosen will be determined by the theme, but could also include such sounds as, for example: the sound of rain falling, the sound of wind, birds chirping, a train whistle and/or the sound of a train on train tracks, geese in flight, mourning dove, temple bells, chimes, thunderstorm, the sound of a stream or ocean surf, crickets, frogs and the like.

Additional specific themed combinations of visual elements and sounds are provided below merely as additional examples of the kind of theming which is possible, and are not intended to be limiting.

| | MOVEABLE | |
|---|---|---|
| FIXED ELEMENTS | ELEMENTS | SOUND |
| Boat, dock and lake | rain; wet leaves | rain falling |
| Foot bridge over a | dandelions and butterflies | water running |
| stream with trees | | |
| and flowering | | |
| shrubs in spring | | |
| Steam locomotive and | ash, blossoms, petals | train moving, whistle |
| train on tracks, | | |
| meadow | | |
| Garden with Buddha | petals and butterflies | temple bells |
| and stone path | | |

The most preferable means for generating sound for the present invention is a semiconductor sound chip 24, as shown in FIG. 3. A sound chip typically includes memory for storing a digital sound sequence, and a controller for accessing and playing back the stored sound sequence. The length of the stored sound sequence can be determined by either the amount of memory available to the controller, or the amount of time the sound chip 24 is energized or both. Moreover, the controller may be programmed to continuously replay the stored sound sequence if the sound chip is energized for a period longer than the normal replay time of the entire sound sequence.

The sound chip 24 is powered using appropriate electrical energy from an electrical source 20, which is preferably provided by any battery capable of furnishing the electrical current required to activate the sound chip 24 and any other components requiring electrical energy for their operation. Base 14 can be adapted to hold battery 20 for convenience. Alternatively, electrical energy may also be provided from any other standard AC or DC source, conditioned and modified as needed to transform the source energy to provide the voltage and power needed to operate the sound chip 24 and other electrical components.

A switch 22 is preferably provided for turning the sound chip 20 on. Switch 22 can be selected from any of a variety of conventional switches. For example, one or more metallic touch switches may be mounted on an outer surface of the base so that when the user touches one of the touch switches (e.g., in the act of inverting the container 10 for the purpose of dispersing the movable elements 18) the sound chip 24 will generate the predetermined sound sequence. Alternatively, a motion sensing switch, such as, for example, a tilt switch, can be used to complete a circuit and generate a signal for automatically turning the sound chip 20 on when the orientation of the decorative display is changed (for example, when the display is picked up and inverted to disperse the randomly moveable elements 18. For the purposes of this invention, a tilt switch is any switch which opens or closes a circuit when its orientation is changed. For example, one type of tilt switch is formed from two leads spaced apart in a small sealed container which contains a small quantity of liquid mercury. If the two spaced apart leads are at one end of the container and the mercury is at the other end of the container, the circuit is open. If the orientation of the switch is changed, for example, inverted, the mercury will move by the force of gravity to the end of the container where the leads are located to close the circuit, since current passes through the mercury from one lead to the other. Likewise, a manual switch, such as, for example, a toggle switch, or a remotely controlled switch can be used where one wishes to allow the user to determine when to activate the sound.

A timer 38 may be used to control the amount of time the sound chip 24 is energized (i.e., the amount of time sound is played by the sound chip). Timer 38 may be formed as a part of the circuit on sound chip 24, or may be a separate component interposed between the electric energy source 20 and the sound chip 24, and controlled by switch 22 so that when a signal is generated by switch 22, the timer 38 closes the circuit between electric energy souce 20 and the sound chip 24, starts counting down a predetermined period of time as the sound chip is energized and plays its prerecorded sound, so that when the predetermined time has expired, the timer 38 opens the circuit between the electric energy source 20 and the sound chip 24, removing the flow of electricity to silence the sound chip. A timer control may optionally be provided, for example conveniently mounted on the base 14 or accessible through a remote control device, which allows the user to manually adjust the amount of time for playback from a very short duration to a very long one.

An amplifier and/or speaker 26 will normally be required to make the output of the sound chip audible to the human ear. Speaker 26 is preferably mounted in base 14.

FIG. 3 also illustrates an optional feature where it is desired to incorporate light into one or more of the fixed elements in the diorama. FIG. 3 illustrates a diorama depicting a Japanese Tea Garden, having, for example, a tree, a low table with two seated figures, a chime hanging from the tree, a Japanese gate or archway, and a lantern between the gate and the seated figures. The themed sound sequence could be, for example, the sound of the wind in the trees with the sound of chimes, or if music is desired, suitable calming Japanese music. In such a theme, it may also be desirable to have the lantern light while the sound sequence is being played. This may easily be accomplished by inserting a first end of a fiber optic fiber through a center bore in the lantern pole so that the first end of the fiber optic fiber 30 extends into the lantern itself, which may be covered, for example, by a translucent plastic. The second end of the fiber optic fiber extends through the diorama base and is mounted to an inside bottom surface 34 of the container 10 where it is covered by the base 14 and not visible to the user. A small light source, such as an LED 32, powered by electric source 20 and controlled by switch 22 and/or timer 38, is mounted adjacent to the second end of the fiber optic fiber 30 so that when the light source 32 is energized, the light will be transmitted from the second end to the first end of the fiber optic fiber 30 and impart a glow to the lantern in the diorama. Alternatively, the fixed element to be illuminated can be formed, for example by molding or machining, from a light transmitting material such as that used to create light pipes. The light-transmitting fixed element can then be painted or coated with a suitable paint or coating to make opaque desired portions of the element, and the remaining portions will transmit light. For the example given in FIG. 3, the lantern and pole could be formed from a light transmitting plastic, and the pole and lantern frame painted, leaving only the pole end and the lantern shades unpainted. The lantern is then mounted on the diorama base so that the pole end is positioned adjacent to the inside bottom surface 34 of container 10, opposite light source 32. When light source 32 is energized, the lantern shade illuminates.

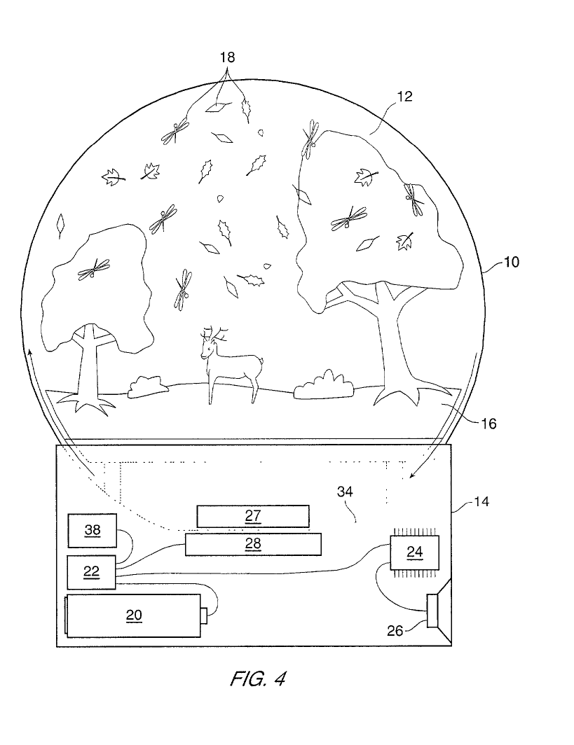

Movement of the randomly movable themed elements is normally obtained by inverting the decorative display in a well-known fashion. However, this method may not be practical or even possible for the user if the container 10 is very large. In such a case, it may be necessary to provide a means for moving the liquid 12. I prefer to avoid using any stirring mechanism which operates by extending through an opening in the container 10, since any such opening provides a route for eventual leakage of the liquid 12 in the container. Rather, I prefer to use a magnetic stirring means which can be operated without any opening in the container. As shown in FIG. 4, the fixed elements of diorama 16 can be mounted on a diorama base which is mounted in a discontinuous fashion leaving openings at the edges for the circulation of both the liquid 12 and the randomly movable elements 18. A magnetic stirring element 17 is placed under the diorama base on the inside bottom surface 34 of container 10. A magnetic stirring impeller 28 is mounted adjacent to the outside bottom surface of container 10, connected to electrical energy source 20 and controlled by switch 22 and/or timer 38, and where it will, when energized, induce the rotation of the magnetic stirring element 17 at a predetermined speed to move liquid 12 in container 10, thus dispersing the randomly movable themed elements 18.

In a particularly preferred embodiment, the themes incorporated into the decorative displays of the present invention are intended to be serene and calming in nature, to aid the user in achieving a relaxed and calm state of mind. To achieve this, natural sounds and dioramas are particularly preferred. For example, FIG. 4 shows a typical springtime diorama with fixed elements such as trees, a meadow, flowers and a deer, and movable themed elements such as butterflies, dragonflies, bees and the like. Such a theme can be matched with the natural sounds of summer such as crickets, birds, and/or running water.

One skilled in the art will recognize at once that it would be possible to construct the present invention from a variety of materials and in a variety of different ways. While the preferred embodiments have been described in detail, and shown in the accompanying drawings, it will be evident that various further modification are possible without departing from the scope of the invention as set forth in the appended claims.

What is claimed is:

1. A themed decorative display comprising:
a base;
a transparent, liquid-filled container mounted on said base;
a diorama mounted inside said liquid-filled container, said diorama including fixed elements designed to convey a predetermined theme;
a plurality of randomly movable themed elements inside said liquid-filled container, said movable themed elements of sufficient size and weight to be dispersed in said liquid when said liquid is moved or agitated, and to fall slowly through the liquid in response to the pull of gravity;
an electronic means mounted in said base for automatically generating a predetermined sound sequence consistent with said theme when a triggering event occurs.

2. The decorative display of claim 1 wherein said plurality of movable elements include two or more types of movable elements.

3. The decorative display of claim 1 wherein said movable elements are provided with shapes consistent with said theme.

4. The decorative display of claim 3 wherein said movable elements are provided with colors consistent with said theme.

5. The decorative display of claim 1 wherein said electronic means for automatically producing said sound sequence consistent with said theme comprise:
a sound chip for playing a pre-programmed sound sequence;
a source of electric energy for operating said sound chip;
a speaker connected to said sound chip for converting the output generated by the sound chip so that it can be heard by a human;
a timer interposed between said means for providing power and said sound chip which can be preprogrammed to allow said sound chip to operate continuously for a preset period of time whereby said said sound chip will play back the programmed sounds when said timer is “on” and will not play back the programmed sounds when said timer is “off;” and, a switch for turning the timer on.

6. The decorative display of claim 5 wherein said sound chip includes computer readable memory for storing said sound sequence and a controller for accessing memory and retrieving and playing said sound sequence when an appropriate signal is received.

7. The decorative display of claim 5 wherein said diorama is construced on a diorama base having openings which allow the passage of the movable elements, and additionally including a magnetic stirring element positioned inside said container beneath said diorama base, and a magnetic impeller mounted in said base and connected to said means for providing power, whereby said magnetic stirring element can be rotated beneath said diorama base for continuously moving said liquid and said movable elements when power is furnished by the means for providing power.

8. The decorative display of claim 5 wherein said switch is one or more selected from the group consisting of: touch switches, manual switches, and movement switches.

9. The decorative display of claim 5 wherein said means for providing power is a battery.

10. The decorative display of claim 5 additionally including an amplifier for selectively boosting the output generated by the sound chip and used to drive the speaker.

11. The decorative display of claim 10 additionally including a volume-control means connected to said amplifier to provide a user-adjustable volume control.

12. The decorative display of claim 5 additionally including a timer adjustment means mounted in said base for allowing a user to adjust the period of time the sound chip will operate when activated.

13. The decorative display of claim 1 wherein said container is substantially in the shape of a sphere.

14. The decorative display of claim 5 wherein one or more fixed diorama elements incorporate light transmitting material for transmitting light from a light source mounted in said base to a desired location in said diorama consistent with said theme.

15. The decorative display of claim 13 wherein said light source is selected from the group consisting of light emitting diodes and light bulbs powered by said means for providing power.
